(19) United States
(12) Patent Application Publication
(10) Pub. No.: US 2006/0236312 A1
(43) Pub. Date: Oct. 19, 2006

(54) Method, system and program product for identifying information for a software application

(75) Inventors: Lloyd W. Allen JR., Cary, NC (US); Jana H. Jenkins, Raleigh, NC (US); Rebecca J. Schaller, Cary, NC (US); David J. Schell, Raleigh, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/105,988

(22) Filed: Apr. 14, 2005

(51) Int. Cl. G06F 9/44

(52) U.S. Cl. 717/163

(57) ABSTRACT

Under the present invention, a software product is analyzed to identify a set of applications/modules that are actually included therewith. Thereafter, information for the set of applications is identified from a library of information for the software product. The information identified is typically limited to information corresponding to features of the set of applications included with the software product (as well as any default information that could be included for all arrangements of the software product). In any event, the information identified is then packaged for future access by an end-user or the like. To this extent, the information can be packaged with the software product on a computer readable medium such as a CD-Rom, diskette, etc., or it can be made available for access over a network (e.g., the Internet).

### BACKGROUND OF THE INVENTION

1. Field of the Invention

In general, the present invention relates to a method, system and program product for identifying information for a software product. Specifically, the present invention provides a way to limit product information to information associated with the applications that are actually included in the software product as well as any default information.

2. Related Art

As software products have become more sophisticated, greater amounts of information/documentation are typically needed for their full operation and comprehension. For example, today a single software product could include several applications/modules, each of which requires its own subset of information. The standard to date has been to develop a library of information for a software product that is packaged or at least made accessible for end-users.

Unfortunately, given the large volumes of information that a library for a single software product could contain, searching and parsing the information has become a time consuming and inefficient process. At best, an end-user can search the entire library using an index, search terms or the like, and then attempt to focus and/or narrow his/her search based on the results that are returned. This process is especially inefficient since many software products are shipped with only a subset of all available applications. For example, software product “A” might be available with twenty applications. However, customer “1” might only purchase the software product with applications “1-5,” while customer “2” might only purchase the software application with applications “10-20.” Providing both customers with the same or complete library of information would likely be unnecessary and lead to frustration when the users attempt to access or search the information.

In view of the foregoing, there exists a need for a method, system and program product for identifying information for a software product. Specifically, a need exists for a system that is capable of determining what applications/modules are included with a software product, and then identifying corresponding information based thereon.

### SUMMARY OF THE INVENTION

In general, the present invention provides a method, system and program product for identifying information for a software product. Specifically, under the present invention, a software product is analyzed to identify a set of applications/modules that are included therewith. Thereafter, information for the set of applications is identified from a library of information. The information identified is typically limited to information that corresponds to features of the application(s) included with the software product, as well as any default information that could be included for all arrangements of the software product. In any event, the information is then packaged for future access by an end-user or the like. To this extent, the information can be packaged with the software product on a computer readable medium such as a CD-Rom, diskette, etc., or it can be made available for access over a network (e.g., the Internet).

A first aspect of the present invention provides a method for identifying information for a software product, comprising: identifying a set of applications included in the software product; and identifying information corresponding to the set of applications from a library of information available for the software product, wherein the information is limited to information corresponding to features provided by the set of applications and default information.

A second aspect of the present invention provides a method for identifying information for a software product, comprising: analyzing the software product to identify a set of applications included in the software product, wherein the set of applications comprises a subset of a plurality of applications that are available for inclusion in the product; identifying information corresponding to the set of applications from a library of information available for the software product; and packaging the information for future searching.

A third aspect of the present invention provides a system for identifying information for a software product, comprising: a system for analyzing the software product to identify a set of applications included in the software product; a system for identifying information corresponding to the set of applications from a library of information available for the software product; and a system for packaging the information for future access.

A fourth aspect of the present invention provides a program product stored on a computer readable medium for identifying information for a software product, the computer readable medium comprising program code for performing the following steps: analyzing the software product to identify a set of applications included in the software product; identifying information corresponding to the set of applications from a library of information available for the software product; and packaging the information for future access.

A fifth aspect of the present invention provides a method for deploying an application for identifying information for a software product, comprising: providing a computer infrastructure being operable to: analyze the software product to identify a set of applications included in the software product; identify information corresponding to the set of applications from a library of information available for the software product; and package the information for future access.

A sixth aspect of the present invention provides computer software embodied in a propagated signal for identifying information for a software product, the computer software comprising instructions to cause a computer system to perform the following functions: analyze the software product to identify a set of applications included in the software product; identify information corresponding to the set of applications from a library of information available for the software product; and package the information for future access.

Therefore the present invention provides a method, system and program product for identifying information for a software product.

### BRIEF DESCRIPTION OF THE DRAWINGS

FIG. 1 shows an illustrative system for identifying information for a software product according to the present invention.

FIG. 2 shows illustrative arrangements of an illustrative software product according to the present invention.

FIG. 3 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

As indicated above, the present invention provides a method, system and program product for identifying information for a software product. Specifically, under the present invention, a software product is analyzed to identify a set of applications/modules that are included therewith. Thereafter, information for the set of applications is identified from a library of information. The information identified is typically limited to information that corresponds to features of the application(s) included with the software product, as well as any default information that could be included for all arrangements of the software product. In any event, the information is then packaged for future access by an end-user or the like. To this extent, the information can be packaged with the software product on a computer readable medium such as a CD-Rom, diskette, etc., or it can be made available for access over a network (e.g., the Internet).

It should be understood that as used herein, the term “application” is intended to refer to a module or component of a software program. Moreover, the term “information” is intended to refer to any documentation (e.g., electronic) associated with the software program such as help for a software program.

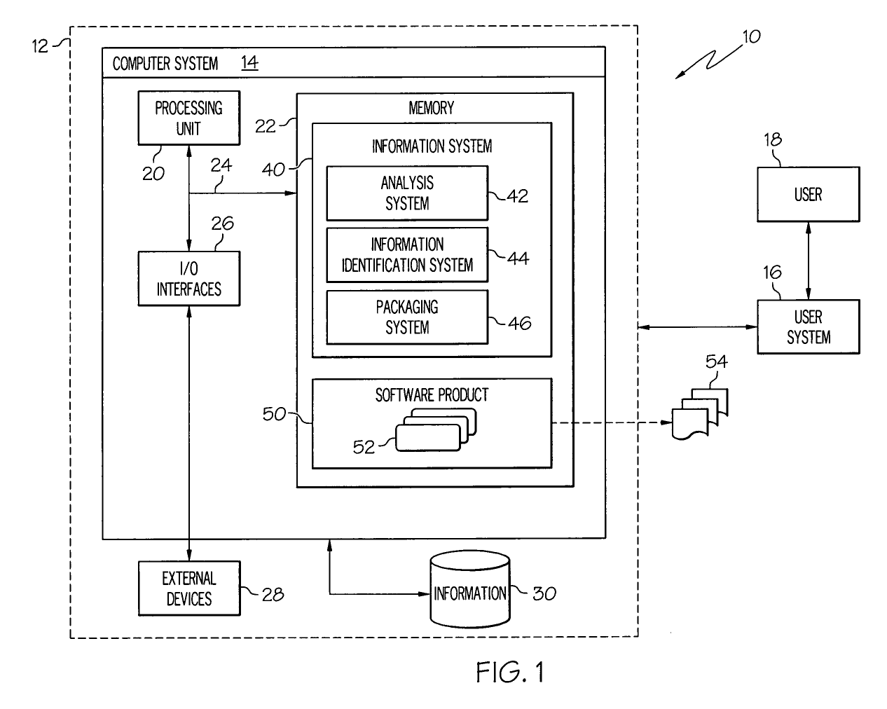

Referring now to FIG. 1, a system 10 for identifying information for a software product 50 according to the present invention is shown. As depicted, system 10 includes a computer infrastructure 12, which comprises a computer system 14 which may be in communication with a user system 16 (also computerized). As will be further described below, computer system 14 will analyze software product 50 to determine what applications 52 are included with software product 50. Based on this analysis, pertinent information is identified and made available for access (e.g., by end-user 18). To this extent, computer system 14 and user system 16 are intended to represent any type of computer systems capable of carrying out the teachings of the present invention. Examples include a laptop computer, a desktop computer, a workstation, and a handheld device. In addition, as will be further described below, computer system 14 can be deployed and/or operated by a service provider that is identifying information for software product 50. Moreover, although not shown, computer system 14 could be part of a larger computer infrastructure that includes any combination of other hardware (e.g., servers and clients) and software.

In the event that computer system 14 and user system 16 communicate with one another (as shown in FIG. 1), such communication can occur over a network (e.g., the Internet, a wide area network (WAN), a local area network (LAN), a virtual private network (VPN), etc. In such a case, communication between computer system 14 and user system 16 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. It should be noted that although computer system 14 and user system 16 are shown in FIG. 1 in communication with one another, this need not be the case. Rather, user system 16 can be “free-standing” with respect to computer system 14.

In any event, computer system 14 is shown including a processing unit 20, a memory 22, a bus 24, and an input/output (I/O) interfaces 26. Further, computer system 14 is shown in communication with external I/O devices/resources 28 and storage system 30. In general, processing unit 20 executes computer program code, such as information system 40, which is stored in memory 22 and/or storage system 30. While executing computer program code, processing unit 20 can read and/or write data, to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices, such as user system 16.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer infrastructures that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14. Moreover, although not shown for brevity purposes, user system 16 will likely contain computerized components similar to computer system 14.

Shown in memory 22 of computer system 14 is information system 40, which includes analysis system 42, information identification system 44 and information packaging system 46. As mentioned above, it is often the case that a single software program 50 can be prepared in different “arrangements” for different customers/end-users. For example, software program “A” might include applications “1-5” for end-user “1,” but include applications “3-10,” for end-user “2.” As such, a software program might include only a subset of all possible applications that could be included therewith. The present invention will analyze software program 50 to determine what application(s) 52 are included therewith. Then, only information pertaining to these applications or their features (plus any default information) will be made available for future access.

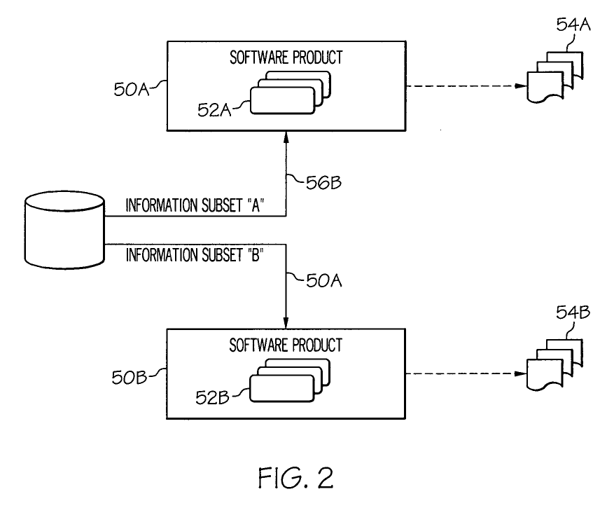

An illustrative embodiment of the invention will be discussed with respect to FIGS. 1-2. Referring first to FIG. 1, assume that end-user 18 wishes to acquire a particular arrangement of software product 50. Under the present invention, analysis system 42 will analyze software product 50 to identify the set (e.g., one or more) of applications 52 that are included therewith. In a typical embodiment, analysis system 42 will analyze configuration files 54 for software product 50 to identify applications 52. Assume in this example, that only applications “1-5” (out of a possible twenty) are included with software product 50 for end-user 18. Once the set of applications 52 have been identified, information identification system 44 will identify the information that corresponds to such applications 50 (or their underlying features/functions). For example, not all information available for a software product is needed for all applications thereof. That is, information for application “1” might not be necessary to exploit/understand application “10.” Information not needed for applications “1-5” could then be eliminated from the information made available to end-user 18 by information identification system 44. To this extent, information identification system 44 will identify the information corresponding to applications 52 (or their features/functions) from the total library of information available for software product. In addition, information identification system 44 could be programmed to identify certain default information that is relevant to all possible applications of software product 50.

Once the information for the arrangement of software product 50 desired by end-user 18 has been identified, it will be packaged by (information) packaging system 46 for future use. In packaging the information under the present invention, many alternatives are possible. For example, the information could be packaged along with software product 50 on a computer readable medium such as a CD-ROM, diskette, etc. In another embodiment, the information could be retained on computer system 14, or on another computer system with which user system 16 communicates. In this latter embodiment, the information would be maintained as an on-line help system or the like. However, unlike previous on-line help systems, the on-line help system for end-user 18's arrangement of software product 50 would include only the information identified by information identification system 44 as corresponding to the application(s) 52 included therewith (plus any default information). This would drastically reduce the volume of information needed to be searched by end-user 18.

Referring to FIG. 2, the teachings of the present invention are further detailed in another illustrative example. In FIG. 2, assume that two different end-users have requested two different arrangements of software product 50, namely arrangements 50A and 50B. Arrangement 50A includes applications 52A, while arrangement 50B includes applications 52B. As indicated above, the present invention will first analyze each arrangement 50A-B to identify their respective applications 52A-B (e.g., by analyzing configuration files 54A-B). Once this has been done, the present invention will identify information for the respective sets of information 56A-B based on applications 52A-B. Thereafter, each sub (or subset in FIG. 2) of information 56A-B will be packaged for future access (e.g., searching) by the end-users.

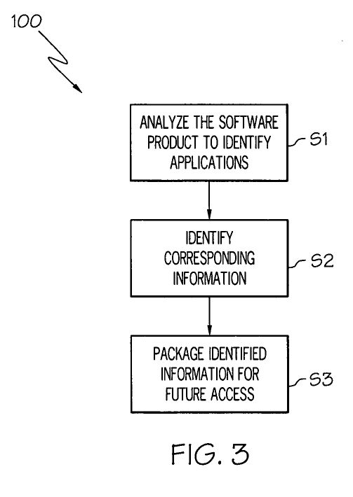

Referring to FIG. 3, a method flow diagram 100 according to the present invention is shown. As shown, first step S1 is to analyze the software product to identify the applications (one or more) included therewith. As indicated above, this typically occurs by analyzing the configuration files or the like for the software product. Once the application(s) are identified, information corresponding thereto will be identified in step S2. The information will typically include information pertaining to the features/functions of the identified applications as well as any default information. Finally, in step S3, the information will be packaged for future access.

While shown and described herein as a method and system for identifying information for a software product, it is understood that the invention further provides various alternative embodiments. For example, in one embodiment, the invention provides a computer-readable medium that includes computer program code to enable a computer infrastructure to identify information for a software product. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to identify information for a software product. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for identifying information for a software product. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for identifying information for a software product, comprising:
identifying a set of applications included in the software product; and
identifying information corresponding to the set of applications from a library of information available for the software product, wherein the information is limited to information corresponding to features provided by the set of applications and default information.

2. The method of claim 1, wherein the set of applications comprises a subset of a plurality of applications that are available for inclusion in the software product.

3. The method of claim 1, further comprising packaging the information for future access.

4. The method of claim 3, wherein the packaging step comprises packaging the information with the software product.

5. The method of claim 3, wherein the packaging step comprises packaging the information for access over a computer network.

6. The method of claim 1, wherein the step of identifying the set of applications comprises analyzing a set of configuration files for the software product to identify the set of applications.

7. The method of claim 1, wherein the information is limited to information associated with features provided by the set of applications included in the software product.

8. The method of claim 1, wherein the information is help information.

9. A method for identifying information for a software product, comprising:
analyzing the software product to identify a set of applications included in the software product, wherein the set of applications comprises a subset of a plurality of applications that are available for inclusion in the product;
identifying information corresponding to the set of applications from a library of information available for the software product; and
packaging the information for future searching.

10. The method of claim 9, wherein the packaging step comprises packaging the information with the software product.

11. The method of claim 9, wherein the packaging step comprises packaging the information for access over a computer network.

12. A system for identifying information for a software product, comprising:
a system for analyzing the software product to identify a set of applications included in the software product;
a system for identifying information corresponding to the set of applications from a library of information available for the software product; and
a system for packaging the information for future access.

13. The system of claim 12, wherein the set of applications comprises a subset of a plurality of applications that are available for inclusion in the software product.

14. The system of claim 12, wherein the system for packaging packages the information with the software product.

15. The system of claim 12, wherein the system for packaging packages the information for access over a computer network.

16. The system of claim 12, wherein the system for analyzing analyzes a set of configuration files for the software product to identify the set of applications.

17. The system of claim 12, wherein the information is limited to information associated with features provided by the set of applications included in the software product.

18. The system of claim 12, wherein the information is help information.

19. A program product stored on a computer readable medium for identifying information for a software product, the computer readable medium comprising program code for performing the following steps:
analyzing the software product to identify a set of applications included in the software product;
identifying information corresponding to the set of applications from a library of information available for the software product; and
packaging the information for future access.

20. The program product of claim 19, wherein the set of applications comprises a subset of a plurality of applications that are available for inclusion in the software product.

21. The program product of claim 19, wherein the packaging step comprises packaging the information with the software product.

22. The program product of claim 19, wherein the packaging step comprises packaging the information for access over a computer network.

23. The program product of claim 19, wherein the analyzing step comprises analyzing a set of configuration files for the software product to identify the set of applications.

24. The program product of claim 19, wherein the information is limited to information associated with features provided by the set of applications included in the software product.

25. The program product of claim 19, wherein the information is help information.

26. A method for deploying an application for identifying information for a software product, comprising:
providing a computer infrastructure being operable to:
analyze the software product to identify a set of applications included in the software product;
identify information corresponding to the set of applications from a library of information available for the software product; and
package the information for future access.
